(19) United States
(12) Patent Application Publication
(10) Pub. No.: US 2014/0001859 A1
(43) Pub. Date: Jan. 2, 2014

(54) POWER GENERATION CONTROL APPARATUS AND POWER GENERATION CONTROL METHOD

(71) Applicant: Sony Corporation, Tokyo (JP)

(72) Inventors: Jusuke Shimura, Kanagawa (JP); Hiroshi Hasegawa, Kanagawa (JP); Atsushi Sato, Kanagawa (JP)

(21) Appl. No.: 13/917,192

(22) Filed: Jun. 13, 2013

(30) Foreign Application Priority Data
Jul. 2, 2012 (JP) 2012-148945

(51) Int. Cl. G05F 5/00

(52) U.S. Cl. CPC G05F 5/00
USPC 307/63; 323/299

(57) ABSTRACT

There is provided a power generation control apparatus including a measurement part measuring a voltage and a current of a photoelectric transducer, a regulation part regulating a current flowing through the photoelectric transducer, and a control part analyzing a shape of a current-voltage curve from the voltage and the current measured by the measurement part, and controlling the regulation part based on a result of the analysis to regulate the current flowing through the photoelectric transducer.

### CROSS REFERENCES TO RELATED APPLICATIONS

The present application claims priority to Japanese Priority Patent Application JP 2012-148945 filed in the Japan Patent Office on Jul. 2, 2012, the entire content of which is hereby incorporated by reference.

### BACKGROUND

The present application relates to a power generation control apparatus and a power generation control method, and specifically, relates to a power generation control apparatus and a power generation control method of controlling power generation of a photoelectric transducer.

A photoelectric transducer (cell) such as a dye-sensitized solar cell and a silicon solar cell is small in output as a single element and a plurality of photoelectric transducers connected in series are used as a module. Such a module configured by a plurality of photoelectric transducers connected in series is called a string.

In the string, when a part of photoelectric transducers constituting it suffer from a shadow, the photoelectric transducers suffering from the shadow decrease the current for the whole string. As a result, this also decreases the amount of power generation of photoelectric transducers under the light. In other words, a significantly small shadow only capable of covering one photoelectric transducer causes a large output drop as if the whole string suffered from a shadow.

Therefore, in order to prevent such an output drop, there is used a technique of providing bypass diodes parallel to individual photoelectric transducers constituting a string. Herein, a system constituted of a photoelectric transducer and a bypass diode connected parallel to the photoelectric transducer is referred to as a photoelectric conversion part.

There are being proposed techniques realized by further improving above-mentioned one in recent years. For example, Japanese Patent Laid-Open No. 2000-68540 (hereinafter referred to as Patent Literature 1) discloses a technique of further providing photocouplers connected to individual solar cells in parallel in addition to bypass diodes and a processing unit outputting information indicating a faulty solar cell based on signals from the photocouplers. Japanese Patent Laid-Open No. 2005-276942 (hereinafter referred to as Patent Literature 2) discloses a technique capable of eliminating bypass diodes from solar battery cells.

### SUMMARY

As mentioned above, in a string provided with bypass diodes parallel to individual photoelectric transducers, under the light uneven on the power generation surface of the string due to a partial shadow or the like, a current large in amount flows through a bypass diode connected to a photoelectric transducer that is relatively dark. There is sometimes a case of deterioration of the bypass diode when the current value exceeds the rated current of the bypass diode. Namely, the photoelectric conversion part deteriorates occasionally.

Some photoelectric transducers represent I-V characteristics as if they included bypass diodes by themselves, that is, behaved like having virtual internal bypass diodes. In a string constituted of such photoelectric transducers, under the light uneven on the power generation surface of the string due to a partial shadow or the like, a photoelectric transducer that is relatively dark deteriorates occasionally.

Accordingly, it is desirable to provide a power generation control apparatus and a power generation control method capable of suppressing deterioration of a photoelectric transducer or a photoelectric conversion part.

According to a first embodiment of the present disclosure, there is provided a power generation control apparatus including a measurement part measuring a voltage and a current of a photoelectric transducer, a regulation part regulating a current flowing through the photoelectric transducer, and a control part analyzing a shape of a current-voltage curve from the voltage and the current measured by the measurement part, and controlling the regulation part based on a result of the analysis to regulate the current flowing through the photoelectric transducer.

According to a second embodiment of the present disclosure, there is provided a power generation control apparatus including a measurement part measuring a voltage and a current of a photoelectric conversion part, a regulation part regulating a current flowing through the photoelectric conversion part, and a control part analyzing a shape of a current-voltage curve from the voltage and the current measured by the measurement part, and controlling the regulation part based on a result of the analysis to regulate the current flowing through the photoelectric conversion part.

According to a third embodiment of the present disclosure, there is a power generation control method including analyzing a shape of a current-voltage curve of a photoelectric transducer, and regulating a current flowing through the photoelectric transducer based on a result of the analysis.

According to a fourth embodiment of the present disclosure, there is a power generation control method including analyzing a shape of a current-voltage curve of a photoelectric conversion part, and regulating a current flowing through the photoelectric conversion part based on a result of the analysis.

In the first and third technologies, it is preferable that the photoelectric transducer has a virtual internal bypass diode. In this case, the analysis of the shape of the current-voltage curve of the photoelectric transducer enables to detect the circumstance of the current flowing through the virtual internal bypass diode of the photoelectric transducer. Moreover, based on the analysis result of the shape of the current-voltage curve, the current flowing through the virtual internal bypass diode of the photoelectric transducer can be regulated.

In the first and fourth technologies, it is preferable that the photoelectric conversion part has a bypass diode. In this case, the analysis of the shape of the current-voltage curve of the photoelectric conversion part enables to detect the circumstance of the current flowing through the bypass diode of the photoelectric conversion part. Moreover, based on the analysis result of the shape of the current-voltage curve, the current flowing through the bypass diode of the photoelectric conversion part can be regulated.

As described above, according to the present application, deterioration of a photoelectric transducer or a photoelectric conversion part can be suppressed.

Additional features and advantages are described herein, and will be apparent from the following Detailed Description and the figures.

### BRIEF DESCRIPTION OF THE FIGURES

FIG. 1 is a schematic diagram illustrating one exemplary configuration of a power generation system according to a first embodiment of the present application;

FIG. 2A is a circuit diagram of a string suffering from a partial shadow;

FIG. 2B is a diagram illustrating a current-voltage curve of the string illustrated in FIG. 2A;

FIG. 3A is a circuit diagram of a string without a partial shadow;

FIG. 3B is a diagram illustrating a current-voltage curve of the string illustrated in FIG. 3A;

FIG. 4A is a circuit diagram of a string suffering from a partial shadow;

FIG. 4B is a diagram illustrating a current-voltage curve of the string illustrated in FIG. 4A;

FIG. 5 is a diagram for explaining a calculation method of a regulation current value;

FIG. 6 is a schematic diagram illustrating one exemplary configuration of the power generation system illustrated in FIG. 1 more specifically;

FIG. 7 is a circuit diagram illustrating specific examples of a current measurement circuit, a current regulation configuration circuit and a current regulation circuit;

FIG. 8 is a flowchart illustrating one example of operation of a power generation control apparatus according to the first embodiment of the present application;

FIG. 9 is a schematic diagram illustrating one exemplary configuration of a power generation system according to a second embodiment of the present application;

FIG. 10 is a schematic diagram illustrating one exemplary configuration of the power generation system illustrated in FIG. 9 more specifically;

FIG. 11 is a schematic diagram illustrating one exemplary configuration of a power generation system according to a third embodiment of the present application;

FIG. 12 is a schematic diagram illustrating one exemplary configuration of the power generation system illustrated in FIG. 11 more specifically;

FIG. 13 is a diagram illustrating one example of a configuration of a home power storage system according to a fourth embodiment of the present application;

FIG. 14 is a diagram illustrating current-voltage curves of a dye-sensitized solar cell and a silicon solar cell;

FIG. 15 is a circuit diagram illustrating an equivalent circuit reproducing the current-voltage curve of the dye-sensitized solar cell illustrated in FIG. 14;

FIG. 16A is an energy diagram illustrating an electron flow in regular power generation of a photoelectric transducer; and

FIG. 16B is an energy diagram illustrating an electron flow when a reverse bias voltage is applied to the photoelectric transducer.

### DETAILED DESCRIPTION

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Embodiments according to the present application are described in the following order.

### 1. SUMMARY

### 2. FIRST EMBODIMENT (Example of Power Generation System Having Virtual Internal Bypass Diode in String)

### 3. SECOND EMBODIMENT (Example of Hybrid Power Generation)

### 4. THIRD EMBODIMENT (Example of Power Generation System Having Bypass Diode in String)

### 5. FOURTH EMBODIMENT (Example of Home Power Storage System)

### 1. SUMMARY

(Difference Between Dye-Sensitized Solar Cell And Silicon Solar Cell)

A dye-sensitized solar cell has several differences from a silicon solar cell most spreading nowadays. Although they are same in generating power under the light irradiation, the structures and constitution materials of both of them are almost not common to each other. Based on such differences, they are still different from each other in various points such as electric characteristics and optical characteristics.

One of the differences is a difference in current-voltage curve (hereinafter referred to as “I-V curve”). In an I-V curve in which the first quadrant represents power generation, where the vertical axis is a current axis and the horizontal axis is a voltage axis, a region in which the voltage is negative (namely, a region of application of reverse bias to the photoelectric transducer), that is, the second quadrant represents a significant difference.

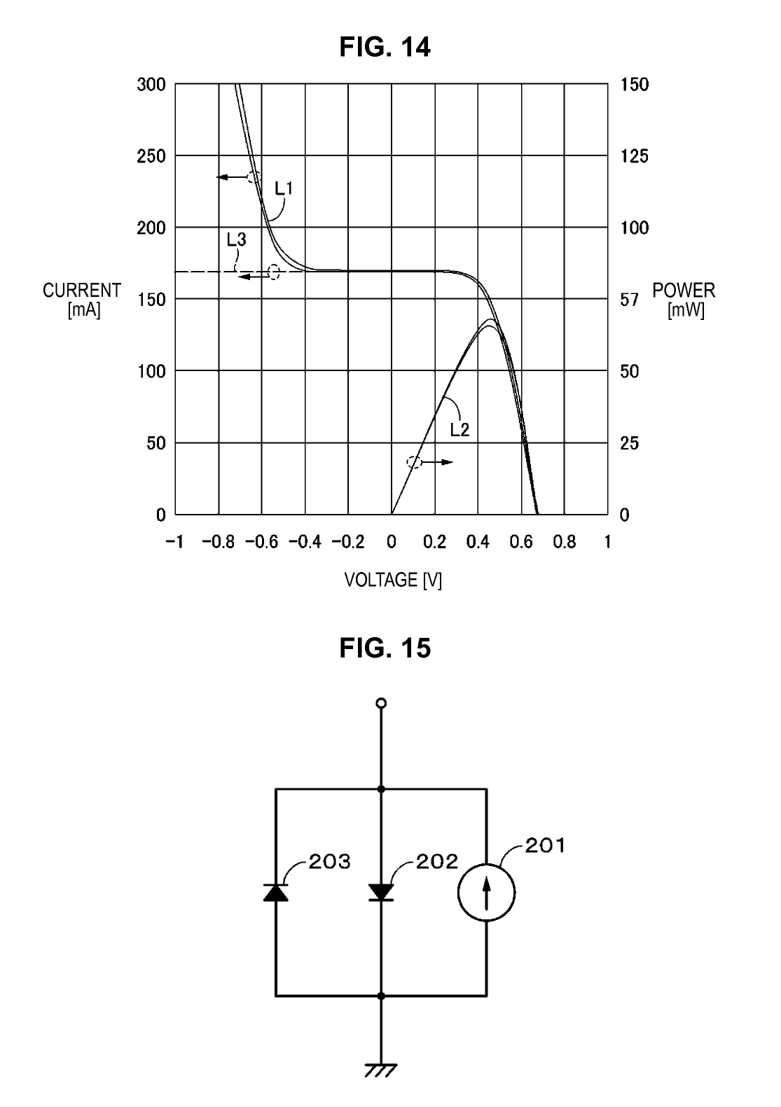

FIG. 14 is a diagram illustrating an I-V curve in the second quadrant. An I-V curve L1 and an I-V curve L3 illustrated in FIG. 14 are an I-V curve of a dye-sensitized solar cell and an I-V curve of a silicon solar cell, respectively. A P-V curve L2 is a P-V curve of the dye-sensitized solar cell. For the silicon solar cell, the I-V curve L3 in the second quadrant is flat. Namely, even when the voltage between the terminals is negative, the current is constant and unchanged. On the other hand, for the dye-sensitized solar cell, when the voltage between the terminals is negative, a large forward current starts to flow suddenly beyond a certain voltage.

FIG. 15 is a circuit diagram illustrating an equivalent circuit reproducing the I-V curve of the dye-sensitized solar cell illustrated in FIG. 14. The equivalent circuit (that is, the equivalent circuit of the dye-sensitized solar cell) is constituted of a current source 201, a diode 202 and a diode 203 which are connected in parallel as illustrating in FIG. 15.

The silicon solar cell does not have the diode 203 in the equivalent circuit illustrated in FIG. 15, that is, the diode 203 in which its anode terminal is connected on the negative electrode side of the cell and its cathode terminal is connected on the positive electrode side in parallel. Namely, the diode 203 is specific for the dye-sensitized solar cell. The presence of the diode 203 accounts for the occurrence of the large forward current in application of a reverse bias voltage to the dye-sensitized solar cell.

The diode 203 included equivalently inside the photoelectric transducer is exceedingly convenient as a solar cell because the diode 203 operates as a bypass diode. The bypass diode is a diode bypassing a photoelectric transducer suffering from a shadow, that is, being a detour of the current, which shadow partially covers a solar cell string configured by two or more photoelectric transducers connected in series.

When such a bypass diode is not present, the photoelectric transducer suffering from a shadow causes a decrease of the current over the whole string including that photoelectric transducer. As a result, this still decreases the amount of power generation of photoelectric transducers under the light. In other words, a significantly small shadow only capable of covering one photoelectric transducer causes a large output drop as if the whole string suffered from a shadow. Since the presence of the bypass diode can prevent such an output drop, the bypass diode is necessary for a solar cell string especially installed in a circumstance of a partial shadow readily arising. Herein, the partial shadow is a shadow partially covering the string, more specifically, a shadow covering a part of photoelectric transducers out of all the photoelectric transducers constituting the string.

As illustrated in FIG. 14 and FIG. 15, the dye-sensitized solar cell has the function of the bypass diode inside. This virtual internal bypass diode, however, is exceedingly poor in characteristics compared with a bypass diode provided, so to speak, externally. It is characterized in that the rated current thereof is low as a diode, and is subjected to deterioration that is visually apparent upon a flow of a current to the extent expected for a general bypass diode. Hereinafter, a reverse bias state is sometimes used for mentioning the state where a current flows through the virtual internal bypass diode included in the photoelectric transducer, caused by a shadow or the like partially covering the string, and thereby, the amounts of power generation among the photoelectric transducers (for example, dye-sensitized solar cells) being uneven. In addition, a reverse bias state is generally used for simply mentioning the state where the photoelectric transducer in the string operates in the second quadrant, that is, the state in which simply Vi<0, where Vi is the voltage between the terminals of the photoelectric transducer. However, the above-mentioned state is sometimes referred to as a reverse bias state for convenience.

(Cause For Deterioration)

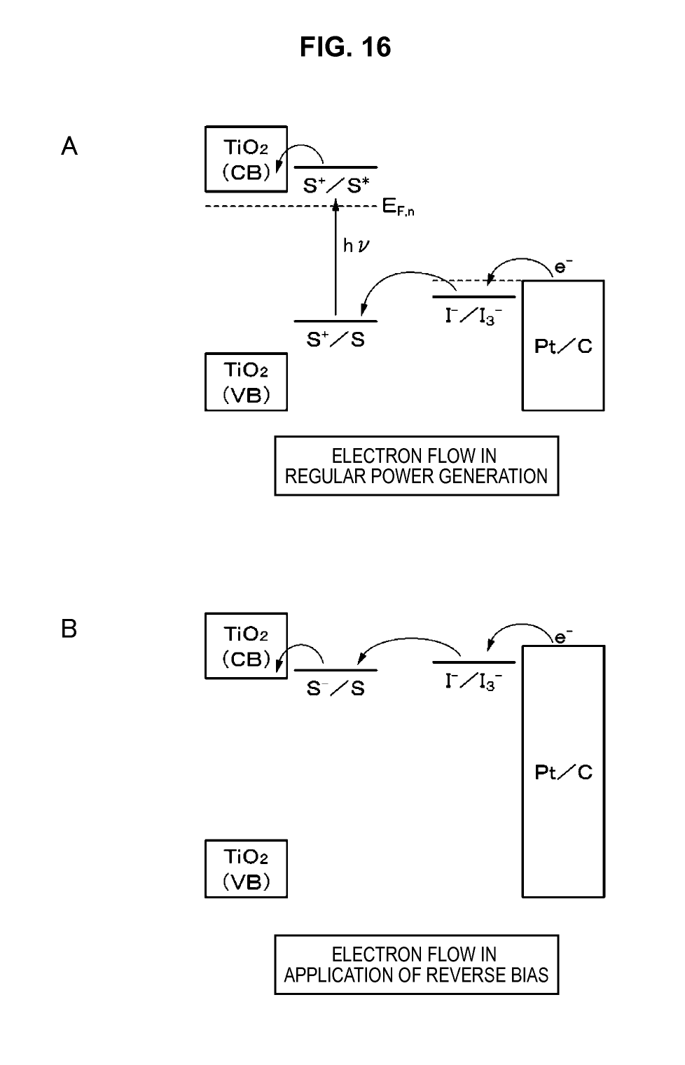

The chief cause for the rated current of the internal bypass diode of the dye-sensitized solar cell being small and readily deteriorating can be explained using energy diagrams illustrated in FIG. 16A and FIG. 16B. FIG. 16A is an energy diagram illustrating an electron flow in regular power generation of the photoelectric transducer. In regular power generation, a dye repeats a cycle of transition from the ground state (S) via the light-excited state (S*) to the radical cation state (S⁺), returning to the original ground state (S).

FIG. 16B is an energy diagram illustrating an electron flow when a reverse bias voltage is applied to the photoelectric transducer. In the application of the reverse bias voltage, the dye passes from the ground state (S) to the radical anion state (S⁻), returning to the original ground state (S). The large difference between them is in the transition via the light-excited state (S*) and the radical cation state (S⁺) or via the radical anion state (S).

The state of a radical anion is a state where one extra electron is present in the molecule and is extremely inconvenient for the state of the dye in the dye-sensitized solar cell because, supposing that this extra electron enters the anti-bonding orbital of the chemical bond joining the dye molecule with titanium oxide, the bond is cleaved and the dye can be eluted in the electrolyte as a free anion. When the current is small the free anion can be absorbed again on titanium oxide, whereas when the current is large the rate of generation of the free anions exceeds the rate of absorption, this causing the irreversible elimination.

Therefore, the engineers of the present application have been studying the photoelectric transducers having the virtual internal bypass diodes (for example, dye-sensitized solar cell) to suppress their deterioration and have developed the application of analyzing the shapes of current-voltage curves of the photoelectric transducers, and based on the analysis results, regulating currents flowing through the photoelectric transducers.

### 2. FIRST EMBODIMENT

(Schematic Configuration Of Power Generation System)

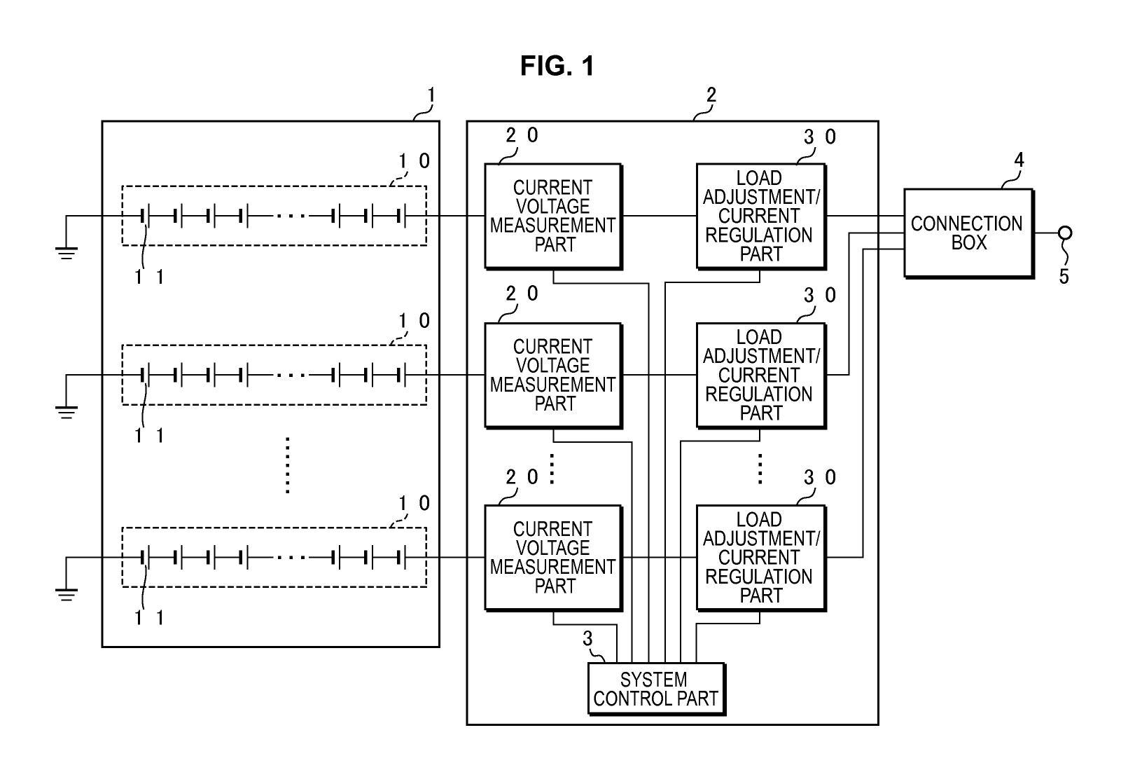

FIG. 1 is a schematic diagram illustrating one exemplary configuration of a power generation system according to a first embodiment of the present application. The power generation system includes a power generation apparatus 1, a power generation control apparatus 2 and a connection box 4 as illustrated in FIG. 1. The power generation apparatus 1 converts light energy into power to output. The power thus outputted is supplied to the connection box 4 via the power generation control apparatus 2. The connection box 4 integrates the power supplied from the power generation apparatus 1 to output to an output terminal 5. The power outputted from the output terminal 5 is supplied, for example, to a power source circuit such as a DC-DC converter (direct current-input direct current-output power source). The power generation control apparatus 2 controls the power generation of the power generation apparatus 1. Such control includes control for preventing deterioration of the power generation apparatus 1.

(Power Generation Apparatus)

The power generation apparatus 1 includes an array (photoelectric transducer group) constituted of a plurality of strings 10. The plurality of strings 10 are connected, for example, electrically in parallel to one another. The string 10 includes photoelectric transducers 11 electrically connected in series. The photoelectric transducer 11 is a photoelectric transducer having a virtual internal bypass diode. Such a photoelectric transducer can employ, for example, a dye-sensitized solar cell (dye-sensitized photoelectric transducer). Herein, the virtual internal bypass diode is a bypass diode included in an equivalent circuit by which the photoelectric transducer 11 is represented. Whether or not a photoelectric transducer 11 has a virtual internal bypass diode can be determined by investigating an I-V curve of the string 10 or the photoelectric transducer 11 (see, FIG. 14).

(Power Generation Control Apparatus)

The power generation control apparatus 2 includes a system control part 3, a plurality of current voltage measurement parts 20 and a plurality of load adjustment and current regulation parts (hereinafter referred to as “load adjustment/current regulation parts”) 30. The current measurement part and the load adjustment/current regulation part 30 are connected to each of the strings 10 constituting the array.

(Current Voltage Measurement Part)

The current voltage measurement part 20 measures a current flowing through the string 10 and a terminal voltage between the both ends of the string 10 based on control of the system control part 3, and supplies the current and voltage thus measured to the system control part 3.

(Load Adjustment/Current Regulation Part)

The load adjustment/current regulation part 30 separates the string 10 from the power line and sets the string 10 in the open state based on control of the system control part 3. Then, maintaining the open state and gradually changing load parallelly connected to the string 10 in one direction, the terminal voltage of the string 10 is swept in one direction. For example, when the load is gradually changed in the decreasing direction, the terminal voltage of the string 10 can be swept from a voltage V_{OC} in the open state to a voltage V_{SC} (=0 V) in the short circuit state. On the other hand, when the load is gradually changed in the increasing direction, the terminal voltage of the string 10 can be swept from the voltage V_{SC} (=0 V) in the short circuit state to the voltage V_{OC} in the open state. Thus, when the terminal voltage of the string 10 is swept, the current voltage measurement part 20 measures the voltages and currents during the sweeping. The voltages and currents thus measured can afford an I-V curve for the whole string. Moreover, the load adjustment/current regulation part 30 regulates the current flowing through the string 10 based on control of the system control part 3.

(System Control Part)

The system control part 3 controls the whole power generation system. The system control part 3 analyzes the shape of the I-V curve over the whole string obtained from the voltages and currents measured by the current voltage measurement part 20, and controls the load adjustment/current regulation part 30 based on the analysis result to regulate the current flowing through the string 10.

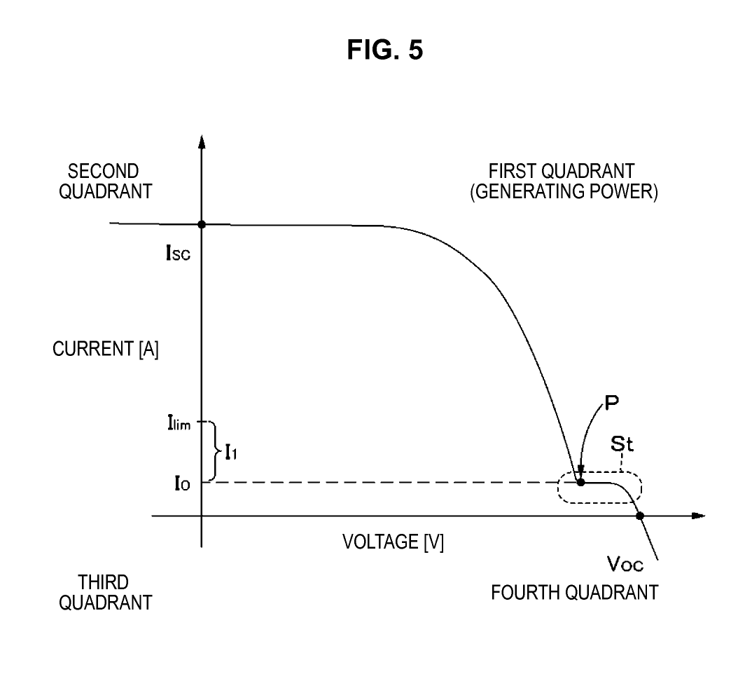

In the analysis of the shape of the I-V curve, for example, the presence or absence of occurrence of a step-like shape St in the I-V curve is determined (see, FIG. 5). A method for such determination of the presence or absence of occurrence of a step-like shape St in the I-V curve can employ, for example, a method in which a dI/dV−V curve is calculated from the I-V curve and the presence or absence of occurrence of a point at which the sign of dI/dV changes, that is, an inflection point P of the current is determined (see, FIG. 5). When it is determined that the occurrence of a step-like shape St is present in the I-V curve, the system control part 3 ends the voltage sweeping by the load adjustment/current regulation part 30, and moreover, controls the load adjustment/current regulation part 30 to regulate the current flowing through the string 10. On the other hand, when it is determined that the occurrence of a step-like shape St is absent in the I-V curve. The system control part 3 continues the voltage sweeping by the load adjustment/current regulation part 30. When it is determined that the occurrence of a step-like shape St is absent over the whole voltage sweeping section and that the voltage sweeping ends over the whole voltage sweeping section, the regulation of the power generation current for the string 10 is released and the string 10 is returned to the power line. Herein, the voltage sweeping section is, for example, a section from the voltage V_{OC} in the open state to the voltage V_{SC} (=0 V) in the short circuit state.

Operation of the voltage sweeping is not limited to the above-mentioned example, but operation of full scanning of the terminal voltage of the string 10 from the voltage V_{OC} in the open state to the voltage V_{SC} (=0 V) in the short circuit state regardless to the presence or absence of occurrence of a step-like shape in the I-V curve over the whole string may be employed. However, in view of reducing time of stopping the regular power generation operation during which the string 10 is separated for detection of a partial shadow, it is preferable to employ the above-mentioned operation of voltage sweeping of ending the voltage sweeping when it is determined that the occurrence of a step-like shape is present. In many cases, information obtained by the full scanning is not necessary but the information is sufficient obtained by referring to log data of hill-climbing method MPPT (Maximum Power Point Tracking) power generation control.

The system control part 3 is preferable to regulate the current flowing through the string 10 as follows when it is determined that the occurrence of a step-like shape is present in the I-V curve over the whole string. Namely, the system control part 3 is preferable to regulate the current flowing through the string 10 such that a current flowing through the virtual internal bypass diode of the photoelectric transducer 11 does not exceed the rated current of the internal bypass diode. More specifically, the system control part 3 is preferable to calculate a regulation current value Iₗᵢₘ using the current value corresponding to the height of the step of the step-like shape in the I-V curve over the whole string, and to apply the current regulation to the string 10 such that the maximum power generation current of the string 10 is equal to or smaller than the regulation current value Iₗᵢₘ. The height of the step of the step-like shape in the I-V curve is, for example, a current I₀ corresponding to the position of the inflection point P in the I-V curve (see, FIG. 5).

Herein, the step-like shape is a step-like shape St occurring from a current I_{OC} in the open state to a current I_{SC} in the short circuit state, as illustrated in FIG. 5, and the flat portion at the height of the current I_{SC} of in the short circuit state is excluded from the step-like shape according to the present application. Specifically, the step-like shape St according to the present application is a shape present around inversion of the sign of voltage differential of the current. The presence or absence of occurrence of the step-like shape St according to the present application can be confirmed by determining whether or not the inflection point P occurs in the I-V curve.

In addition, as mentioned above, the presence or absence of the occurrence of the step-like shape St can lead to detection of the reverse bias state because the object of such state detection is the photoelectric transducer (for example, dye-sensitized solar cell) 11 that has a virtual internal bypass diode. In case of a photoelectric transducer such as a silicon solar cell that does not have an internal bypass diode, illuminance unevenness caused by a partial shadow, if any, does not cause any step-like shape in the I-V curve but only presents a change based on compression in the vertical axis direction (current axis direction). In such a case, it is difficult to determine whether there is a partial shadow or a shadow as a whole only by the measurement of the I-V curve

(Shapes Of I-V Curves)

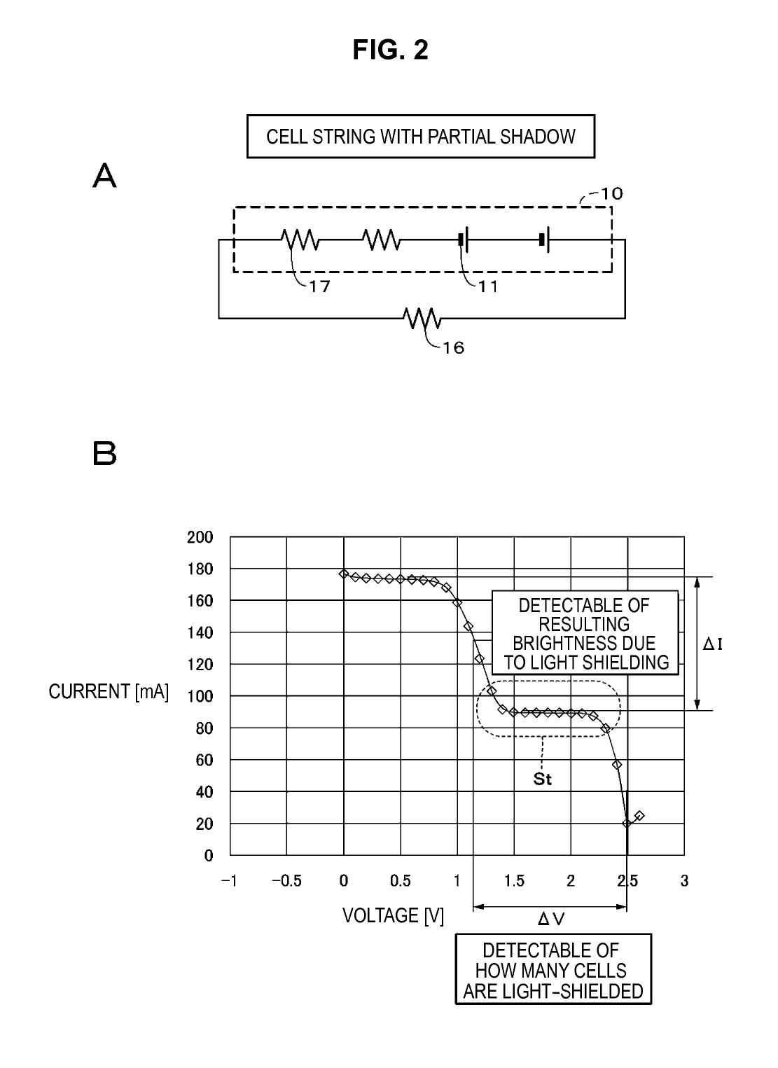

FIG. 2A is a circuit diagram of a string in occurrence of a partial shadow. FIG. 2B is a diagram illustrating an I-V curve of the string illustrated in FIG. 2A. In addition, in FIG. 2A, an example of connection of a load 16 to one string 10 in the power generation apparatus 1 is illustrated, simplifying the illustration. The string 10 is constituted of four photoelectric transducers 11, 11, 17 and 17 connected in series. The photoelectric transducer 11 represents a photoelectric transducer in regular power generation operation which is irradiated with sufficient light. On the other hand, the photoelectric transducer 17 represents a photoelectric transducer suffering from a shadow as a resistance preventing a flow of current. Herein, as one example, it is supposed that the photoelectric transducer 17 suffering from a shadow is irradiated with light approximately a half in amount at most compared with the photoelectric transducer 11 that is irradiated with sufficient light.

As illustrated in FIG. 2B, the occurrence of the step-like shape St can be confirmed in the I-V curve of the string 10 in the above-mentioned state. Such a step-like shape arises from the two photoelectric transducers 11, out of four, that are irradiated with sufficient light and the rest two photoelectric transducers 17 that are irradiated with light approximately a half in amount at most compared with the photoelectric transducer 11 during the measurement of the I-V curve. Namely, the step-like shape St in the I-V curve means the presence of illuminance unevenness among the photoelectric transducers constituting the string 10. Analysis of the step-like shape St enables to determine the quantity of how many photoelectric transducers and how much they are light-shielded out of the photoelectric transducers 11 included in the string 10. Specifically, analysis of the height ΔI of the step enables to determine the quantity of how much the photoelectric transducers 17 are light-shielded. Moreover, analysis of the width ΔV of the step and the number N of steps enables to determine the quantity of how many photoelectric transducers are light-shielded out of the photoelectric transducers 11. When there are plural photoelectric transducers 17 suffering from shadows and the areas of the shadows over them (that is, ratios of light shielding) are equal to one another, the more the number of the photoelectric transducers 17 suffering from the shadows is, the wider the width ΔV of the step is. When there are plural photoelectric transducers 17 suffering from shadows and the areas of the shadows over them (that is, ratios of light shielding) are different from one another, the number N of steps increases in response to the number of photoelectric transducers 17 suffering from the shadows.

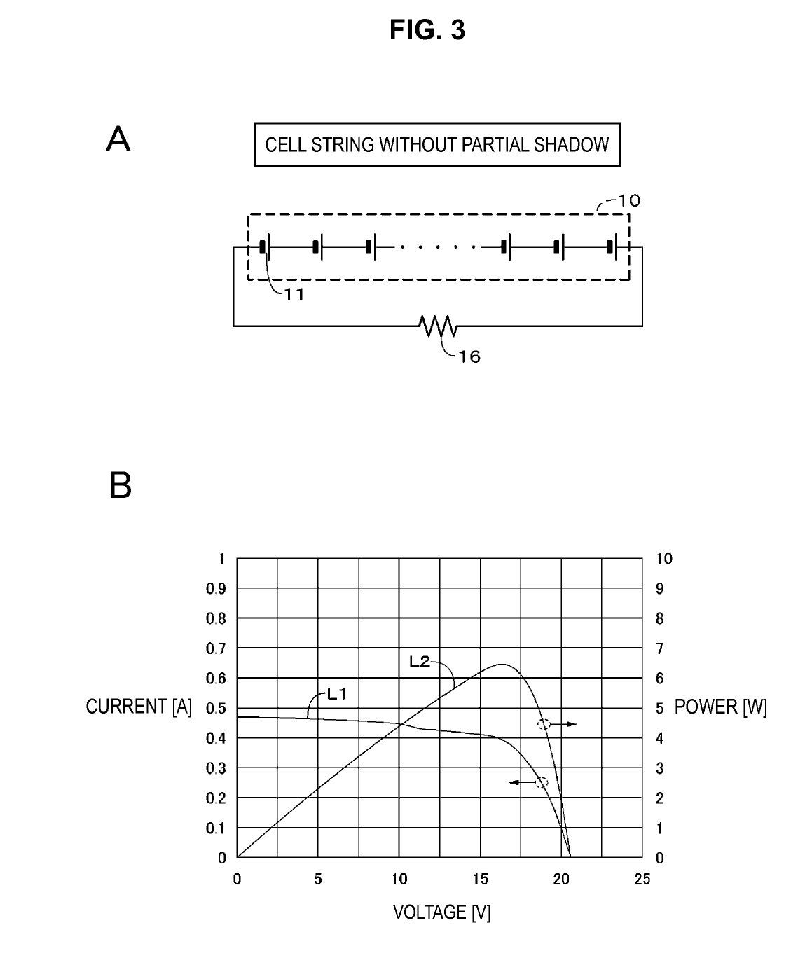

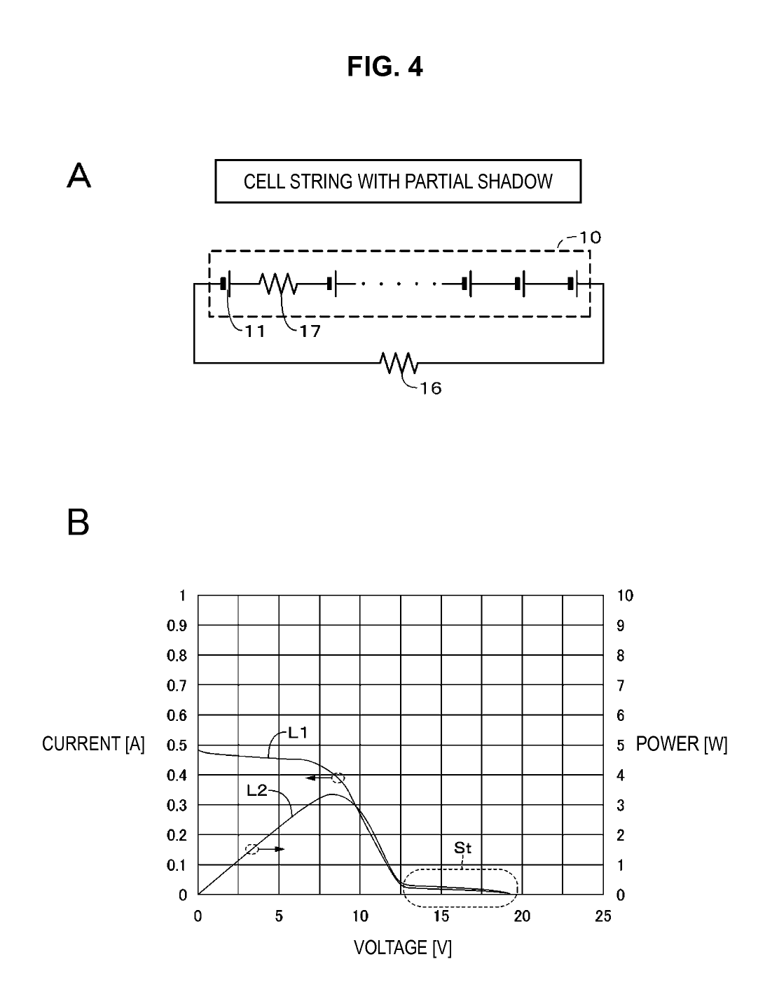

FIG. 3A is a circuit diagram of a string without occurrence of a partial shadow. FIG. 3B is a diagram illustrating an I-V curve of the string illustrated in FIG. 3A. FIG. 4A is a circuit diagram of a string in occurrence of a partial shadow. FIG. 4B is a diagram illustrating an I-V curve of the string illustrated in FIG. 4A. In addition, in each of FIG. 3A and FIG. 4A, an example of connection of the load 16 to one string 10 in the power generation apparatus 1 is illustrated, simplifying the illustration. In each of FIG. 3B and FIG. 4B, the curve L1 represents an I-V curve and the curve L2 represents a P-V curve.

The string 10 illustrated in each of FIG. 3A and FIG. 4A is constituted of 32 photoelectric transducers 11 connected in series. In addition, the photoelectric transducer 17 illustrated in FIG. 4A represents a photoelectric transducer suffering from a shadow as a resistance preventing a flow of current. When there is no occurrence of a partial shadow and the amounts of power generation of the plural photoelectric transducers 11 constituting the string 10 are approximately even, as illustrated in FIG. 3B, there is no occurrence of a step-like shape St in the I-V curve L1. On the other hand, when there is occurrence of a partial shadow and the amounts of power generation of the plural photoelectric transducers 11 constituting the string 10 are not even, as illustrated in FIG. 4B, there is occurrence of a step-like shape St in the I-V curve L1.

Comparing the step-like shape St in the I-V curve L1 of FIG. 2B with that of the I-V curve L1 of FIG. 4B, the height of the step (height of the flat portion) in FIG. 4B is lower than the height of the step (height of the flat portion) in FIG. 2B. The step in FIG. 4B being lower than the step in FIG. 2B means that the photoelectric transducer 17 in FIG. 4A is darker than the photoelectric transducer 17 in FIG. 2B due to the partial shadow. Namely, the photoelectric transducer 17 in FIG. 4A is more liable of occurrence of reverse bias, which causes severe conditions, than the photoelectric transducer 17 in FIG. 2B. More specifically, the photoelectric transducer 17 in FIG. 4A is more liable to allow a current exceeding the rated current, which causes severe conditions, to flow through the virtual internal bypass diode than the photoelectric transducer 17 in FIG. 2B.

Accordingly, the system control part 3 analyzing the shape of the I-V curve can acquire various kinds of information regarding the status of the string 10. For example, determining the presence or absence of occurrence of a step-like shape in the I-V curve over the whole string enables to determine whether or not a current exceeding the rated current is liable to flow through the virtual internal bypass diode.

As mentioned above, determining the presence or absence of occurrence of a step-like shape in the I-V curve over the whole string enables the system control part 3 to determine whether or not there is any photoelectric transducer 11 that is in the state where a current flows through the virtual internal bypass diode out of the plural photoelectric transducers 11 constituting the string 10. Namely, it can be determined whether or not there is any photoelectric transducer 11 that is in the state where a current flows through the virtual internal bypass diode, this caused by a shadow or the like partially covering the string 10 of the power generation apparatus 1, and thereby, the amounts of power generation among the photoelectric transducers being uneven.

(Calculation Method Of Regulation Current Value)

FIG. 5 is a diagram for explaining a calculation method of the regulation current value Iₗᵢₘ. The regulation current value Iₗᵢₘ is a current value for preventing deterioration of the photoelectric transducers 11 caused by reverse bias. The power generation control apparatus 2 calculates the regulation current value Iₗᵢₘ using the above-mentioned step-like shape St occurring in the I-V curve L1 as follows.

First, controlling the load adjustment/current regulation part 30, the voltage is swept in one direction. Moreover, the shape of the I-V curve over the whole string based on the voltages and currents measured by the measurement part is analyzed during the sweeping. Specifically, for example, the I-V curve is created using the voltages and currents measured by the measurement part during the sweeping, and it is determined whether or not there is occurrence of a step-like shape in the I-V curve thus created. When the occurrence of a step-like shape St is determined, a current I₀ corresponding to the height of the step (at the inflection point P) in the created I-V curve is acquired. Next, the value obtained by adding a constant I₁ to the current I₀ thus acquired (I₀+I₁) is calculated and the value is set to the regulation current value Iₗᵢₘ. On the other hand, when no occurrence of a step-like shape St is determined, the voltage sweeping is continued and the creation of the I-V curve is continued. In addition, the constant I₁ is a constant inherent to the photoelectric transducer 11. When the photoelectric transducer 11 is a dye-sensitized solar cell, the constant I₁ is a constant inherent to the dye-sensitized solar cell which is defined based on the surface area of titanium oxide and its micropore structure, the kind of dye and its absorption amount, the kind of electrolyte, and the like. In addition, the constant I₁ is substantially equal to the rated current of the virtual internal bypass diode of the photoelectric transducer 11. Moreover, the value obtained by subtracting the current I₀ from the current I flowing through the string 10 (I-I₀) is substantially equal to a current I_{b} flowing through the virtual internal bypass diode of the photoelectric transducer 11.

(Constant I₁)

Hereafter, the constant I₁ in the case of the photoelectric transducer 11 being a dye-sensitized solar cell is described. When the current is forced to be externally flown through the dye-sensitized solar cell suffering from a shadow and not generating power, the following six phenomena take place sequentially inside the photoelectric transducer (see, FIG. 16).

(1) An electron entering the counter electrode material from the external circuit is handed over to the neighboring mediator molecule. The mediator molecule having received the electron is converted into the reductant (iodide ion I⁻). The counter electrode material often employs platinum or carbon. The mediator molecule often employs a triiodide ion I₃⁻ or the like.

(2) The mediator molecule as the reductant migrates in the electrolyte by phoresis, convection, diffusion and the like and reaches a dye molecule absorbed on the titanium oxide electrode.

(3) The mediator molecule collides with the dye molecule, and during the process, the electron is handed over from the mediator molecule to the dye molecule (namely, the redox between the mediator molecule and the dye molecule takes place). Due to the electron transfer, the mediator molecule returns to the oxidant (for example, triiodide ion I₃⁻) and the dye molecule is converted into the reductant (dye anion radial).

(4) The mediator molecule having returned to the oxidant migrates in the electrolyte by phoresis, convection, diffusion and the like again to return in the vicinity of the counter electrode.

(5) The dye molecule as the reductant (dye anion radial) hands over to the conduction band of the titanium oxide on which itself is absorbed to return to the oxidant.

(6) The electron having entered the conduction band of the titanium oxide reaches the transparent conductor as a collector material through the inside of the titanium oxide, and passes through toward the external circuit. The transparent conductor often employs fluorine-doped tin oxide.

In order to prevent deterioration of the photoelectric transducer, it is expected that all these six steps take place smoothly. Supposed that the step (5) is disrupted, the dye molecules as the reductant (dye anion radials) accumulate inside the photoelectric transducer, and leaving this happening, the dye molecules are subjected to reductive elimination from the titanium oxide.

The constant I₁ as a current value is preferable to be matched to the rate in the step which is slowest and a bottleneck out of the six steps.

(Specific Configuration Of Power Generation System)

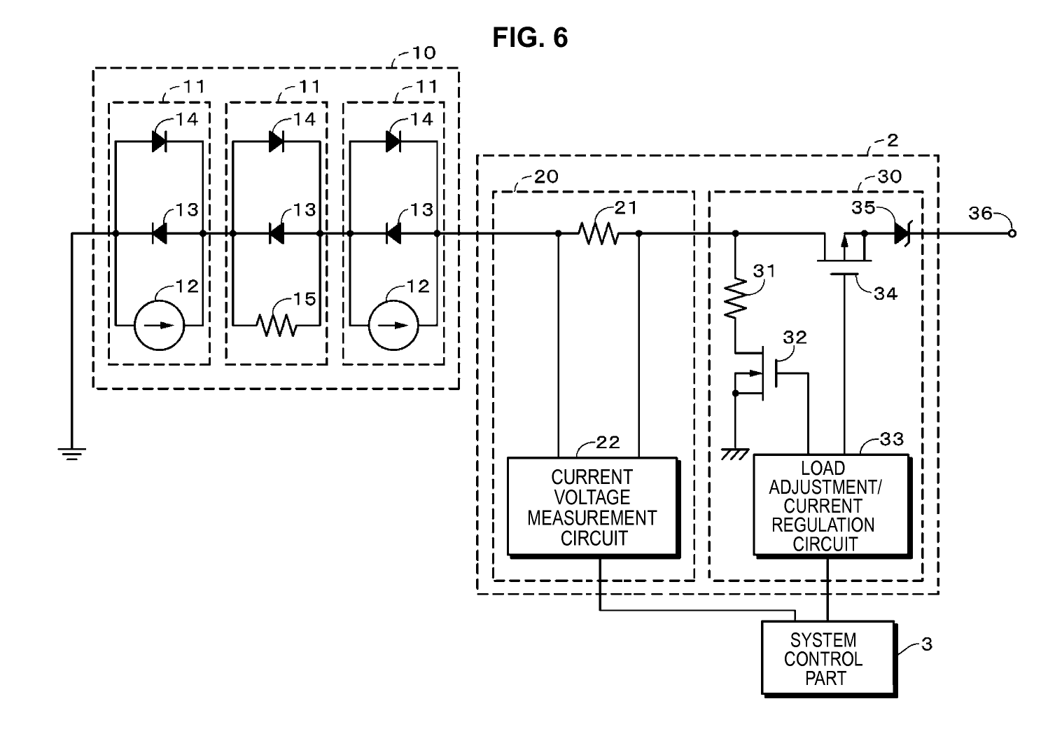

FIG. 6 is a schematic diagram illustrating one exemplary configuration of the power generation system illustrated in FIG. 1 more specifically. As mentioned above, the string includes a plurality of photoelectric transducers 11 connected in series. In FIG. 6, an example is illustrated in which the string 10 includes three photoelectric transducers 11 connected in series.

In FIG. 6, the photoelectric transducers 11 are represented by equivalent circuits. The equivalent circuits of the photoelectric transducers 11 are different from each other for the photoelectric transducer 11 that does not suffer from a partial shadow and performs regular power generation or for the photoelectric transducer 11 that suffers from a partial shadow and does not perform regular power generation. Namely, the equivalent circuit of the photoelectric transducer 11 that does not suffer from a partial shadow and performs regular power generation includes a current source 12, a diode 13 and a bypass diode 14 which are connected in parallel. The equivalent circuit of the photoelectric transducer 11 that suffers from a partial shadow and does not perform regular power generation includes a resistance 15, a diode 13 and a bypass diode 14 which are connected in parallel. Namely, the photoelectric transducer 11 that does not perform regular power generation is different from the photoelectric transducer 11 that performs regular power generation in inclusion of the resistance 15 in place of the current source 12.

The current voltage measurement part 20 includes a shunt resistance 21 connected to the string 10 in series and a current voltage measurement circuit 22 connected to the both ends of the shunt resistance 21. The load adjustment/current regulation part 30 includes an n-channel FET (Field Effect Transistor) 32, a p-channel FET 34, a resistance 31, a load adjustment and current regulation circuit (hereinafter referred to as “load adjustment/current regulation circuit”) 33, and a Schottky barrier diode 35. The source terminal of the n-channel FET 32 is grounded. The gate terminal of the n-channel FET 32 is connected to the load adjustment/current regulation circuit 33. The drain terminal of the n-channel FET 32 is connected between the shunt resistance 21 and an output terminal 36 via the resistance 31. The p-channel FET 34 is provided between the shunt resistance 21 and the output terminal 36. The drain terminal of the p-channel FET 34 is connected for the shunt resistance 32 and the source terminal thereof is connected to the output terminal 36 via the Schottky barrier diode 35. The gate terminal thereof is connected to the load adjustment/current regulation circuit 33. The current voltage measurement circuit 22 is connected to the system control part 3, and operation of current voltage measurement is controlled based on control signals from the system control part 3. The load adjustment/current regulation circuit 33 is connected to the system control part 3, and operation of load adjustment and current regulation based on control signals from the system control part 3.

The power generation system configured as mentioned above operates as follows. Setting the p-channel FET 34 in the open state, a gate voltage of the n-channel FET 32 is changed gradually, this allowing the load to the string 10 to change gradually. During the load to the string 10 changing gradually, each of the voltages at the both ends of the shunt resistance 21 is measured by the current voltage measurement circuit 22, this allowing the I-V curve to be obtained. Moreover, setting the n-channel FET 32 of the current voltage measurement circuit 22 in the open state, the gate voltage of the p-channel FET 34 is controlled, this enabling to drive the string 10 equal to or smaller than the regulation current value Iₗᵢₘ, and in addition, to output the current from the output terminal 36.

A circuit for regulating the current through the string 10 to Iₗᵢₘ, can employ the above-mentioned circuit obtained by combining the current voltage measurement part 20 using the shunt resistance 21 with the load adjustment/current regulation part 30 using the p-channel FET 34. This, however, is just one example and, for example, a current measurement device of magnetic field detection type such as a Hall sensor may be employed in place of the shunt resistance 21 and a PNP transistor may be used in place of the p-channel FET 34.

(Current Measurement Circuit, Current Regulation Configuration Circuit And Current Regulation Circuit)

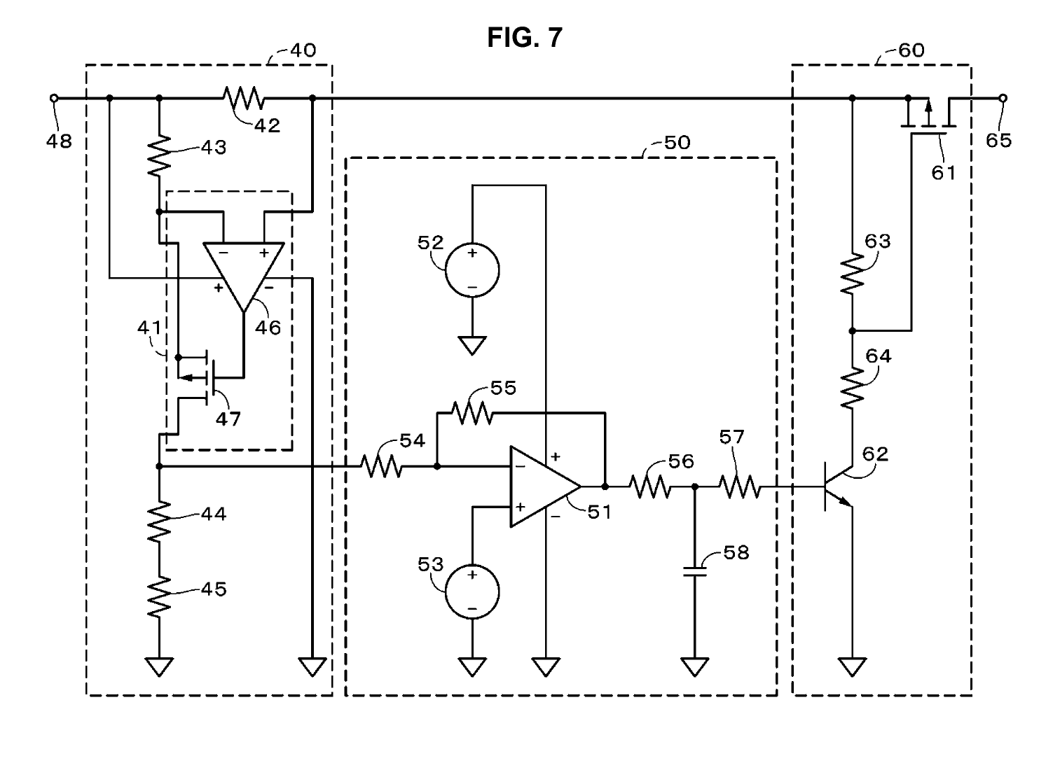

FIG. 7 illustrates specific examples of a current measurement circuit, a current regulation configuration circuit and a current regulation circuit. A current measurement circuit 40 includes a current detection amplifier 41, a shunt resistance 42 and resistances 43, 44 and 45 as illustrated in FIG. 7. The current detection amplifier 41 includes, for example, an amplifier 46 and a p-channel FET 47. The inversion input terminal and the non-inversion input terminal of the current detection amplifier 41 are connected to the both ends of the shunt resistance 42, respectively. The resistance 43 is provided between the inversion input terminal of the current detection amplifier 41 and one end of the shunt resistance 42. The resistance 44 and the resistance 55 are connected to the output terminal of the current detection amplifier 41 in series.

A current regulation configuration circuit 50 includes an amplifier 51, direct-current voltage sources 52 and 53, resistances 54, 55, 56 and 57, and a capacitor 58 as illustrated in FIG. 7. The resistance 54 is connected between the inversion input terminal of the amplifier 51 and the output terminal of the current detection amplifier 41. One end of the resistance 55 is connected between the inversion input terminal of the amplifier 51 and the resistance 54, and the other end thereof is connected between the output terminal of the amplifier 51 and the resistance 57. The direct-current voltage source 53 is connected to the non-inversion input terminal of the amplifier 51. The output terminal of the amplifier 51 is connected to one end of the resistances 56 and 57 connected in series, and the other end of the resistances 56 and 57 is connected to a current regulation circuit 60. One end of the wiring drawn from between the resistances 56 and 57 connected in series is connected to the capacitor 58. The direct-current voltage source 53 is connected to the amplifier 51.

The current regulation circuit 60 includes a p-channel FET 61, an npn-type transistor 62 and resistances 63 and 64. The source terminal of the p-channel FET 61 is connected to one end of the shunt resistance 42. The drain terminal of the p-channel FET 61 is connected to an output terminal 65. The gate terminal of the p-channel FET 61 is connected between the resistances 63 and 64 connected in series. One end of the resistances 63 and 64 connected in series is connected between the shunt resistance 42 and the source terminal of the p-channel FET 61. The other end of the resistances 63 and 64 connected in series is connected to the collector terminal of the npn-type transistor 62. The base terminal of the p-channel FET 61 is connected to the output terminal of the amplifier 51 via the resistances 56 and 57 connected in series.

(Operation Of Power Generation Control Apparatus)

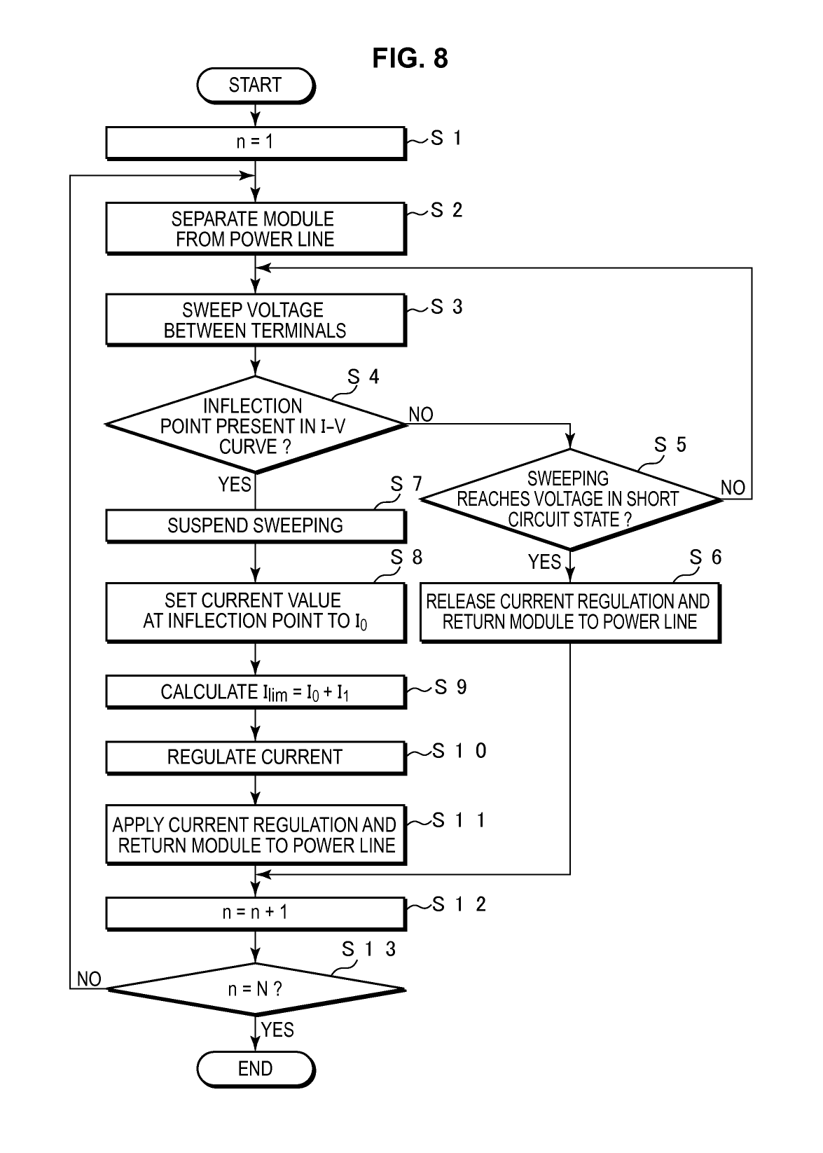

FIG. 8 is a flowchart illustrating one example of operation of the power generation control apparatus according to the first embodiment of the present application. Herein, operations of detection of a partial shadow and regulation of a current are described as the operation of the power generation control apparatus. In addition, such operations are started, for example, upon a trigger of any of the following items (1) to (3).

(1) at a constant interval from the sunrise to the sunset (for example, every 10 minutes).

(2) at the time point when the output of the array and/or the string varies in time and the output of the array and/or the string drops at a level (for example, at the time point when, comparing an output Pb before a predetermined time period (for example, before 10 minutes) with an current output Pa, the ratio α [%] of the current output Pa to the output Pb before the predetermined time period (=(Pa/Pb)×100) drops equal to or smaller than a predetermined value).

(3) In a system configured by connecting a plurality of strings, at the time point when an output Ps for only one string drops compared with an average output Pt for the other strings (for example, at the time point when the ratio β [%] of the difference between the output Ps for the one string and the average output Pt for the other strings (=(Pt−Ps)/Pt)×100) becomes equal to or greater than a predetermined value)

First, in step S1, the system control part 3 initializes a number n for a string (module) 10 as the measurement object to set it to an initial value “1”. In addition, the number of the string 10 is stored, for example, in a storage included in the system control part 3. Next, in step S2, the system control part 3 controls the load adjustment/current regulation part 30 to temporarily separate the string 10 with the number n as the measurement object from the power line and to set it in the open state. Next, in step S3, the system control part 3 controls the load adjustment/current regulation part 30 to sweep the voltage between the terminals of the string 10 as the object from the voltage V_{OC} in the open state toward the voltage V_{SC} in the short circuit state (=0 V) at a constant rate and to measure the current values and the voltage values by the current voltage measurement part 20 during the sweeping. Thereby, the system control part 3 obtains the I-V curve of the string from the current values and the voltage values supplied form the current voltage measurement part 20.

Next, in step S4, performing the voltage sweeping, the system control part 3 determines whether or not the I-V curve that is in a voltage range (range of V to V_{OC}) having been acquired at that time has an inflection point. In step S4, when it is determined that any inflection point is not present, in step S5, the system control part 3 determines whether or not the sweeping reaches 0 V (voltage in the short circuit state). In step S5, when it is determined that the sweeping does not reach the voltage V_{SC} in the short circuit state (=0 V), the system control part 3 returns the process to step S3 and continues the voltage sweeping. On the other hand, in step S5, when it is determined that the voltage sweeping reaches the voltage V_{SC} in the short circuit state (=0 V), in step S6, the system control part 3 control the load adjustment/current regulation part 30 to release the regulation of power generation current to the string 10 as the measurement object to return it to the power line.

In step S4, when it is determined that an inflection point is present, in step S7, the system control part 3 controls the load adjustment/current regulation part 30 to suspend the voltage sweeping and not to perform the voltage sweeping after that. Next, in step S8, the system control part 3 sets the current value at the inflection point to the current I₀. Next, in step S9, the system control part 3 adds the constant I₁ inherent to the string to the current I₀, and sets it to a regulation current Iₗᵢₘ(=I₀+I₁). In addition, the current I₀, constant I₁ and regulation current Iₗᵢₘ are stored, for example, in the storage included in the system control part 3. Next, in step S10, the system control part 3 controls the load adjustment/current regulation part 30 to apply current regulation such that the maximum power generation current of the string 10 as the measurement object is Iₗᵢₘ, and in that state, in step S11, the string 10 is returned to the power line.

Next, in step S11, the system control part 3 increments the number n of the string 10 as the measurement object. Next, in step S12, the system control part 3 determines whether or not the number n of the string 10 as the measurement object reaches the number N of the strings 10 constituting the array of the power generation apparatus 1. In step S12, when it is determined that the number n of the string 10 reaches the number N, the system control part 3 ends the process. On the other hand, in step S12, it is determined that the number n of the string 10 is not the number N, the system control part 3 returns the process to step S2.

(Effects)

According to the above-mentioned first embodiment, the system control part 3 determines the presence or absence of occurrence of a step-like shape in the I-V curve. Then, in the case of the occurrence of a step-like shape, the system control part 3 controls the load adjustment/current regulation part 30 to regulate the current flowing through the string 10. Accordingly, under the circumstances of power generation with light uneven on the power generation surface of the string 10 due to a partial shadow or the like, deterioration of the photoelectric transducer 11 that is relatively dark. Moreover, the combination of functions of the acquisition of the I-V curve over the whole string and the analysis of the shape of the acquired I-V curve enables to detect reverse bias.

As a method of detecting a partial shadow in a silicon solar cell, it is known, for example, to use a photocoupler disclosed in Patent Literature 1. This method includes parallelly connecting a photocoupler to a bypass diode attached to each photoelectric transducer in parallel, and detecting reverse bias via the photocoupler. In applying the method to a string of dye-sensitized solar cells, determination of the regulation current value Iₗᵢₘ is to be a method of gradually decreasing the regulation current value even upon turning-on of one photocoupler, and employing the regulation current value at the time point when all the photocouplers have been turned off. Moreover, a method of using an amplifier as disclosed in Patent Literature 2 also can work equivalently in principle. In this case, however, the rated voltage of the amplifier itself tends to be a problem.

However, in these methods, the number of circuit components increases proportional to the number of the photoelectric transducers and the wiring becomes more complex, this directly causing higher costs and being a demerit. Hence, these are not effective especially for strings each having a number of photoelectric transducers. On the contrary, the method according to the present application which can be realized only by measurement of an I-V curve and by using a shape analyzing algorithm can suppress the number of components even in case of the increasing number of photoelectric transducers 11 and can make the bypass diode unnecessary.

<Variation>

The cause for occurrence of distortion such as a step-like shape in the I-V curve is not only a partial shadow. Such distortion occurs in the I-V curve also in case of fault of several photoelectric transducers 11 constituting the string 10.

Specifying the cause can be performed, for example, most simply by leaving history of circumstances of occurrence of distortion in a storage and investigating the phenomenon as being temporary or continuing. Being temporary means a partial shadow and being continuing does fault of photoelectric transducers 11 highly possibly.

Specifying the cause more precisely can be performed by leaving the value I₀/I_{SC} in the occasion of occurrence of the distortion as well in the storage as history. In case of a fine day, since a directly reaching light component (collimated component of insolation) is major, the extent of a current drop in shielding is high, and therefore, the value I₀/I_{SC} is small. On the other hand, in case of a cloudy day, since a scattering light component (non-collimated component of insolation), the extent of a current drop in shielding is low, and therefore, the value I₀/I_{SC} is large. Under the ambient conditions, the extent of a current drop is high and low, that is, not necessarily constant. On the contrary, in case of fault of photoelectric transducers 11, the extent of a current drop is substantially constant, this being the different to be detected.

When the cause for the distortion occurring in the I-V curve is a partial shadow, a smaller value I₀/I_{SC} indicates that the cause for the shadow is proximal to the string 10, and a larger value I₀/I_{SC} indicates that the cause distal thereto as a general tendency. Combination of this distance information and another sensor, time information and the like enables to make estimation more in detail. For example, when the surface temperature is zero degrees centigrade and there is occurrence of a partial shadow, the cause is snow highly possibly. When there is a partial shadow at the same time every day, a shadow of a neighboring building or a shadow of a tree is highly possible. In addition, in case of the tree being deciduous, since the value I₀/I_{SC} varies according to seasons (that is, more suffering from a shadow in summer when tree leaves are flourish and less suffering from a shadow in winter when tree leaves are few), analyzing the history of the value I₀/I_{SC} also enables to discriminate a shadow of a building or a shadow of a tree. When the cause for a partial shadow is very close to the string 10 in autumn, the cause is fallen leaves highly possibly. A partial shadow irregularly and randomly occurring in time is probably a bird, a plane or the like highly possibly.

The cause for the distortion in the I-V curve is estimated, for example, by such algorithm and if it is estimated as snow or fallen leaves, the user is preferable to be notified and the snow or fallen leaves is to be removed. In case of a building or a tree, the user is also preferable to be notified, but in case of a bird or a plane, it is not necessary for the user to be notified in particular.

When the cause is fault of photoelectric transducers 11, it is preferable that output history and/ or history of various kinds of sensors by the fault is stored in the storage, and further, the user is prompted to contact the customer center. The user directly transmits the history data to the customer center via the Internet or the like, this being useful for investigating the cause for the fault.

In addition, when the cause is found as fault of photoelectric transducers 11 and I₀ is extremely small, it is possible not to apply current regulation on purpose. Although this leaves the fault of the relevant photoelectric transducers 11 progressing, by giving up protection of those photoelectric transducers 11, power generating performance of the string as a whole can be recovered. Since the relevant photoelectric transducers 11 have already gone to malfunction, giving up the protection thereof often causes no problem.

### 3. SECOND EMBODIMENT

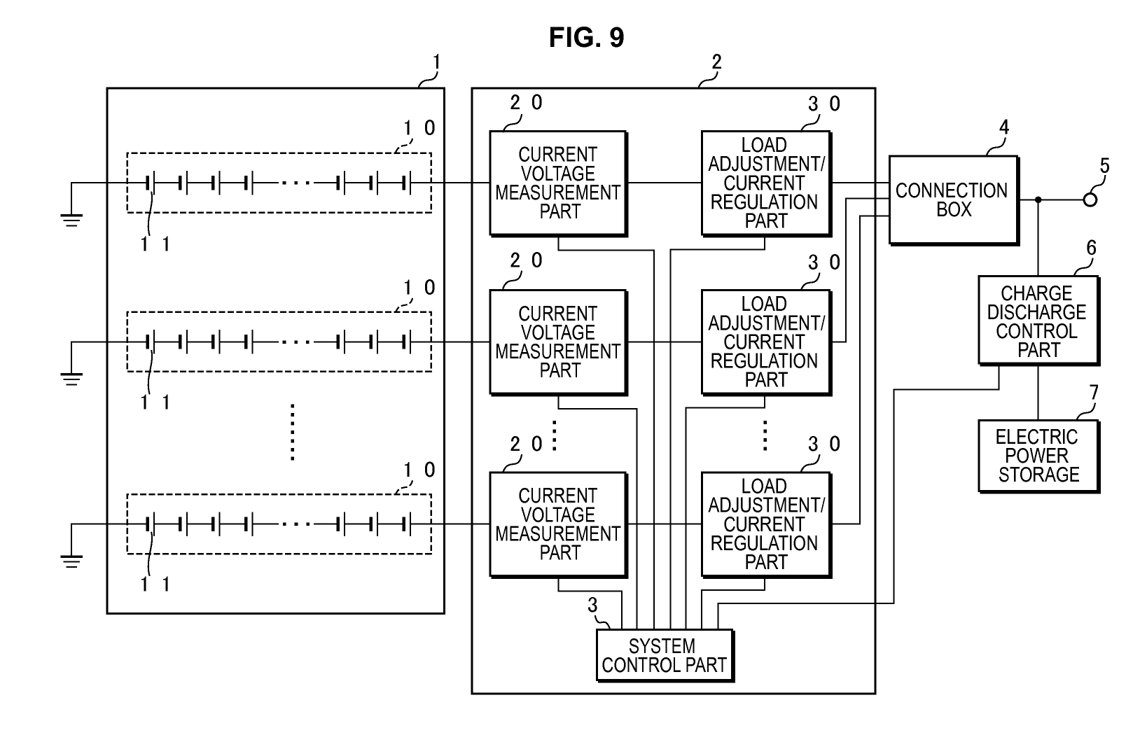

FIG. 9 is a schematic diagram illustrating one exemplary configuration of a power generation system according to a second embodiment of the present application. The power generation system according to the second embodiment is a hybrid power generation system using photoelectric transducers (for example, dye-sensitized solar cells) and a storage battery (for example, lithium ion secondary battery). In the second embodiment, the portions same as in the first embodiment are provided with the same reference characters, omitting the description thereof.

The power generation system according to second embodiment further includes a charge discharge control part 6 and an electric power storage 7, this being different from that according to first embodiment. The electric power storage 7 is provided between the connection box 4 and the output terminal 5 via the charge discharge control part 6. The electric power storage 7 includes, for example, a plurality of storage batteries connected in series and/or in parallel. The storage batteries are preferable to employ lithium ion secondary batteries.

The power integrated in the connection box 4 is charged in the electric power storage 7 via the charge discharge control part 6. The power charged in the electric power storage 7 is supplied to the output terminal 5 via the charge discharge control part 6. The charge discharge control part 6 is connected to the system control part 3 and, based on whose control, operation of charge discharge of the electric power storage 7 is controlled.

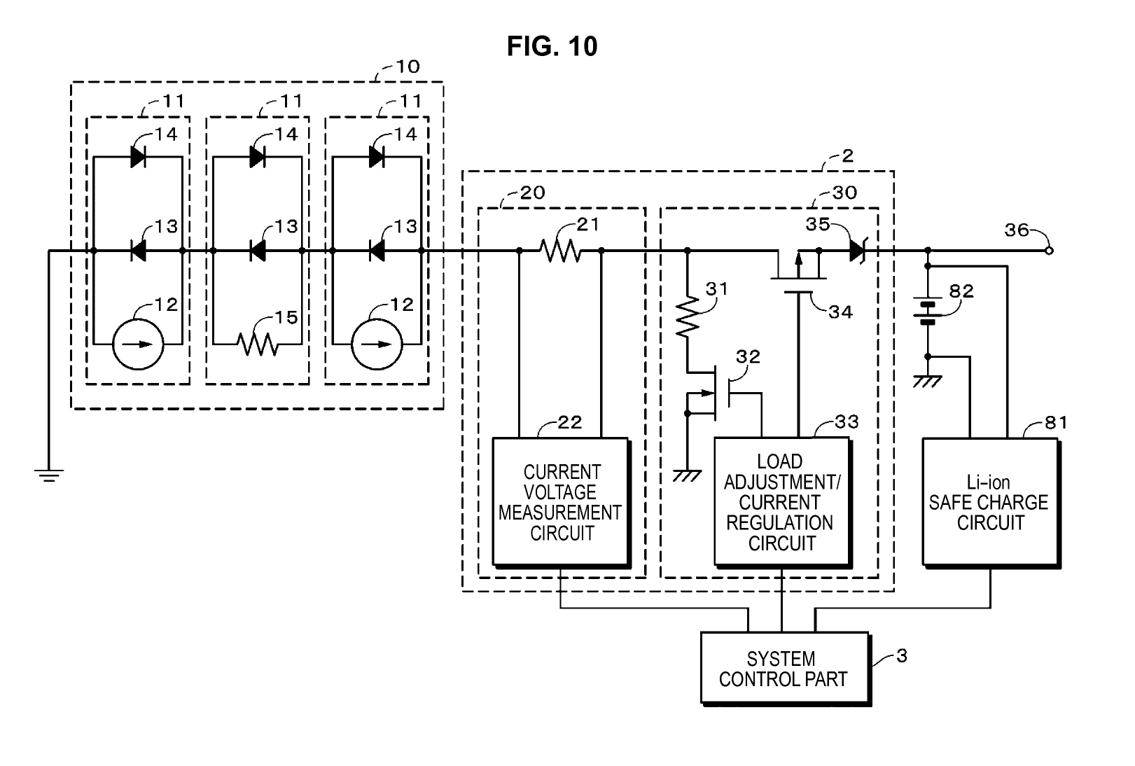

FIG. 10 is a schematic diagram illustrating one exemplary configuration of the power generation system illustrated in FIG. 9 more specifically. A group cell 82 configured by connecting storage batteries in series and/or in parallel is provided between the connection box 4 and the output terminal 5. A safe charge circuit 81 is provided with respect to the group cell 82 in parallel. The safe charge circuit 81 is connected to the system control part 3 and, based on whose control, operation of charge discharge control of the safe charge circuit 81 is controlled.

### 4. THIRD EMBODIMENT

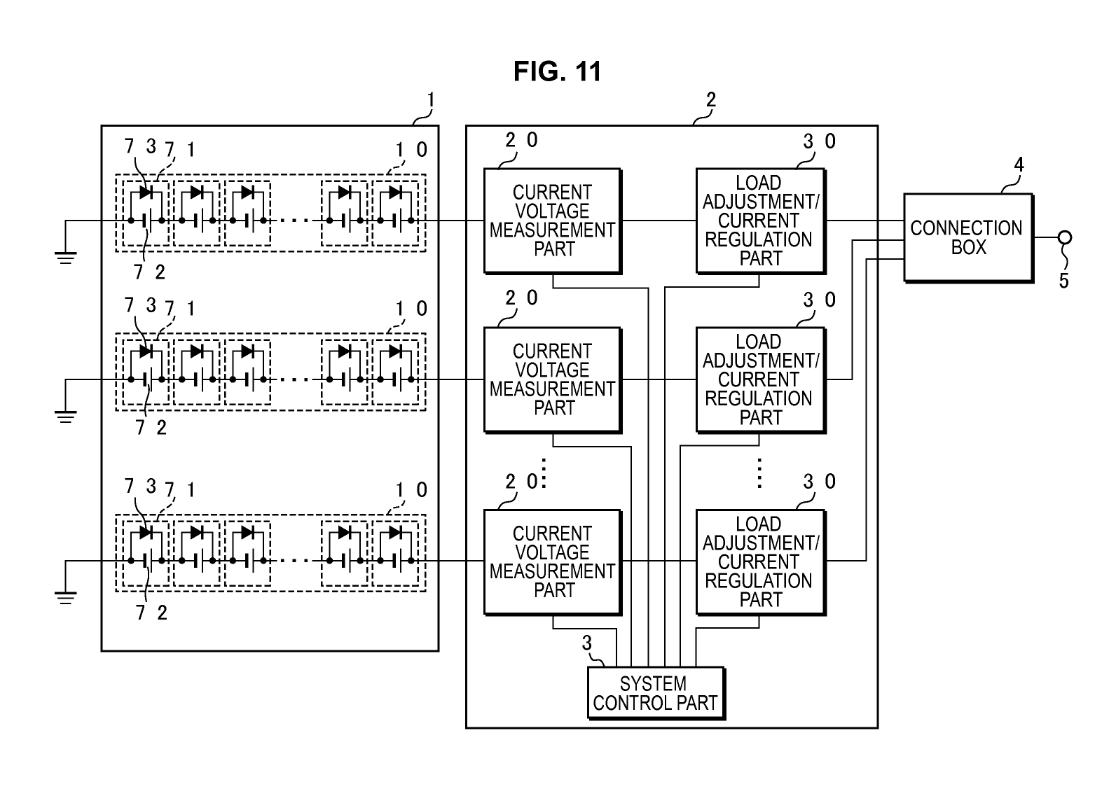

FIG. 11 is a schematic diagram illustrating one exemplary configuration of a power generation system according to a third embodiment of the present application. The third embodiment is different from first embodiment in the string 10 constituted of photoelectric conversion parts 71 connected in series. The photoelectric conversion part 71 includes a photoelectric transducer 72 and a bypass diode 73 connected to the photoelectric transducer 72 in parallel. In the first embodiment, the photoelectric transducers 11 constituting the string 10 have virtual internal bypass diodes, and on the contrary, in the third embodiment, the photoelectric transducers 72 constituting the string 10 have actual bypass diodes 73, this discriminating the embodiments from each other in their configurations. In the third embodiment, the portions same as in the first embodiment are provided with the same reference characters, omitting the description thereof.

The photoelectric transducer 72 is a photoelectric transducer without a virtual internal bypass diode. Such photoelectric transducers can include, for example, a silicon-based solar cell, but are not limited to this example in particular. Such silicon-based solar cells can include, for example, a single crystal silicon-type solar cell, a polycrystalline silicon-type solar cell, a fine crystalline silicon-type solar cell and an amorphous silicon-type solar cell, but are not limited to these in particular.

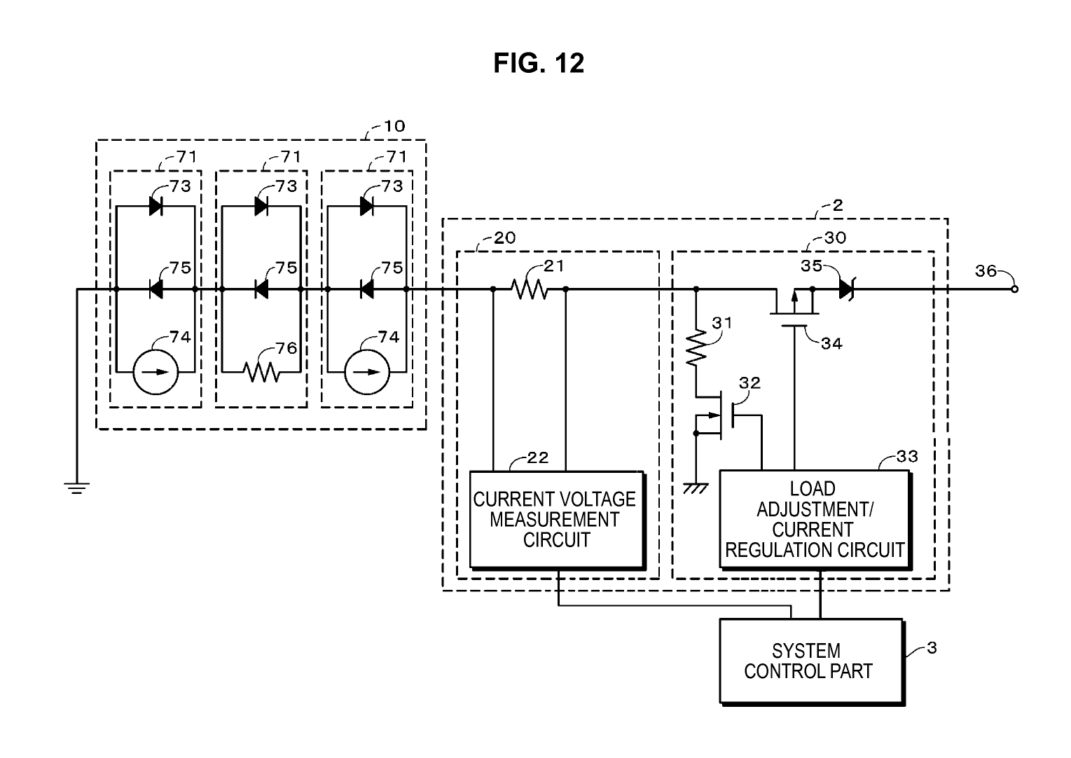

FIG. 12 is a schematic diagram illustrating one exemplary configuration of the power generation system illustrated in FIG. 11 more specifically. In FIG. 12, the photoelectric transducers 72 are represented by equivalent circuits. The equivalent circuits of the photoelectric transducers 72 are different from each other for the photoelectric transducer that does not suffer from a partial shadow and performs regular power generation or for the photoelectric transducer that suffers from a partial shadow and does not perform regular power generation. Namely, the equivalent circuit of the photoelectric transducer 72 that does not suffer from a partial shadow and performs regular power generation includes a current source 74, a bypass diode 73 and a diode 75 which are connected in parallel. The equivalent circuit of the photoelectric transducer 72 that suffers from a partial shadow and does not perform regular power generation includes a resistance 76, a bypass diode 73 and a diode 75 which are connected in parallel. Namely, the photoelectric transducer 72 that does not perform regular power generation is different from the photoelectric transducer 72 that performs regular power generation in inclusion of the resistance 76 in place of the current source 74.

### 5. FOURTH EMBODIMENT

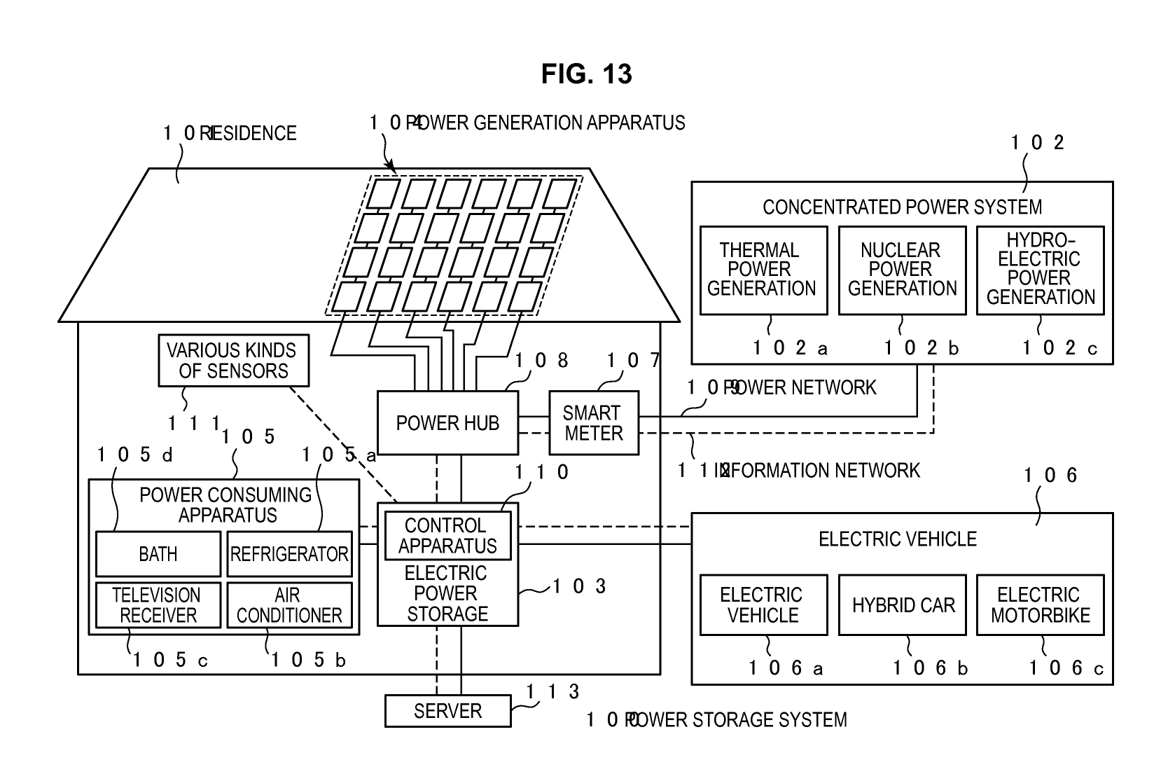

FIG. 13 is a diagram illustrating one example of a configuration of a home power storage system according to a fourth embodiment of the present application. For example, in a power storage system 100 for a residence 101, power is supplied from a concentrated power system 102 such as a thermal power generation 102a, a nuclear power generation 102b and a hydroelectric power generation 102c to an electric power storage 103 via a power network 109, an information network 112, a smart meter 107, a power hub 108 and the like. Along with these, power is supplied from an independent power supply such as a power generation apparatus 104 to the electric power storage 103. The power supplied to the electric power storage 103 is stored, and using the electric power storage 103, the power used in the residence 101 is supplied. The same power storage system can be used for a building as well as the residence 101 not limitedly.

The residence 101 is provided with a power generation apparatus 104, power consuming apparatuses 105, the electric power storage 103, a control apparatus 110 controlling the individual apparatuses, the smart meter 107, and sensors 111 acquiring various kinds of information. The individual apparatuses are connected via a power network 109 and an information network 112. The power generated by the power generation apparatus 104 is supplied to the power consuming apparatuses 105 and/or the electric power storage 103. The power generation apparatus 104 can employ the power generation apparatus 1 according to the above-mentioned first or third embodiment. The power consuming apparatuses 105 are a refrigerator 105a, an air conditioner 105b, a television receiver 105c, a bath 105d and the like. Furthermore, the power consuming apparatuses 105 include electric vehicles 106. The electric vehicles 106 are an electric vehicle 106a, a hybrid car 106b, an electric motorbike 106c and the like.

The electric power storage 103 includes, for example, a plurality of lithium ion secondary batteries connected in series and/or in parallel. The smart meter 107 has functions of measuring the usage of the commercial power and transmitting the usage to the electric power company. The power network 109 may be configured by any one of a direct-current power supply, an alternating-current power supply and a non-contact power supply or any combination of those.

Various kinds of sensors 111 include, for example, a human sensor, an illuminance sensor, an object body detecting sensor, a power consumption sensor, a vibration sensor, a contact sensor, a thermal sensor, an infrared sensor and the like. Information acquired by the various kinds of sensors 111 are transmitted to the control apparatus 110. The information from the sensors 111 enables to comprehend the status of climate, the status of people and the like and to control the power consuming apparatus 105 automatically to minimize the energy consumption. Furthermore, the control apparatus 110 can transmit information regarding the residence 101 to the electric power company and the like outside via the Internet.

The power hub 108 performs branching power lines, conversion between direct current and alternating current, and the like. Communication systems of the information network 112 connected to the control apparatus 110 include usage of a communication interface such as UART (Universal Asynchronous Receiver-Transceiver: transceiver circuit for asynchronous serial communication), and usage of a sensor network based on a wireless communication standard such as Bluetooth, ZigBee and Wi-Fi. Bluetooth can be applied to multimedia communication and can mediate communication with one-to-many connections. ZigBee uses a physical layer based on IEEE (Institute of Electrical and Electronics Engineers) 802.15.4. IEEE 802.15.4 is the name of a short-distance wireless network standard called PAN (Personal Area Network) or WPAN (Wireless Personal Area Network).

The control apparatus 110 is connected to an external server 113. The server 113 may be managed by any of the residence 101, the electric power company and the service provider. Information transmitted and received by the server 113 includes power consumption information, life pattern information, electricity rates, weather information, natural calamity information and information regarding electricity transactions. These kinds of information may be transmitted and received from the household power consuming apparatuses (for example, television receiver), whereas they may be transmitted and received from devices except the household apparatuses (for example, a mobile phone and the like). These kinds of information may be displayed on equipment having a display function such, for example, as a television receiver, a mobile phone and a PDA (Personal Digital Assistants).

The control apparatus 110 controlling the individual portions is constituted of a CPU (Central Processing Unit), a RAM (Random Access Memory), a ROM (Read Only Memory) and the like. In this example, it is mounted in the electric power storage 103. The control apparatus 110 is connected to the electric power storage 103, the power generation apparatus 104, the power consuming apparatus 105, the various kinds of sensors 111 and the server 113 via the information network 112, and has, for example, a function of adjusting the usage of the commercial power and the amount of power generation. In addition, otherwise, it may have a function of making electricity transactions in the electric power market. The control apparatus 110 has the functions of the above-mentioned power generation control apparatus 2 according to the first embodiment.

As above, the power can be stored in the electric power storage 103 as the generated power of the power generation apparatus 104 (solar power generation and/or wind power generation) as well as the concentrated power system 102 such as the thermal power generation 102a, the nuclear power generation 102b, the hydroelectric power generation 102c. Accordingly, a fluctuation of the generated power of the power generation apparatus 104, if any, can be controlled such that the power amount transferred to the outside is made constant or the discharge is made as necessary. For example, the power obtained by the solar power generation is stored in the electric power storage 103, and in addition, the power in the midnight which is low in rate during the night is stored in the electric power storage 103. That power stored in the electric power storage 103 can be discharged for use during the time zone when the rate is high in the daytime, as one usage manner.

In addition, an example in which the control apparatus 110 is mounted in the electric power storage 103 is described, whereas it may be mounted in the smart meter 107 or may be configured solely. Furthermore, the power storage system 100 may be used for a plurality of families in an apartment building or for a plurality of detached residences.

### EXAMPLES

Hereafter, the present application is described specifically using Example and Comparative Example, whereas the present application is not limited only to these examples.

### Example

First, a string obtained by connecting 64 dye-sensitized solar cells in series was prepared. Next, the string was connected to a power generation control apparatus having a function of preventing deterioration. Such a power generation control apparatus employed one having the configuration illustrated in FIG. 1 and operating according to the flowchart illustrated in FIG. 8. As above, a desired power generation system was obtained.

### Comparative Example

First, a string obtained by connecting 64 dye-sensitized solar cells in series was prepared. Next, the string was connected to an existing power generation control apparatus not having a function of preventing deterioration. As above, a desired power generation system was obtained.

(Evaluation)

The function of preventing deterioration of the power generation system obtained as above was evaluated as follows. First, one dye-sensitized solar cell in the string of the power generation system was pasted with a light shielding tape to light-shield it, this resulting in only one dye-sensitized solar cell in the string suffering from a partial shadow as a virtual circumstance. Next, after the string of the power generation system underwent power generation test outside for a constant period, the light-shielded dye-sensitized solar cell was observed by eyes.

(Results)

For the power generation system of Comparative Example, pale colored spots which likely indicated elimination of the dye were observed in some portions of the light-shielded dye-sensitized solar cell. The factor of the deterioration is considered that the current flowed through the internal bypass diode of the light-shielded dye-sensitized solar cell at all times during the power generation test and that the current value exceeded the rated current of the internal bypass diode.

On the other hand, for the power generation system of Example, no pale colored spots which likely indicated elimination of the dye were observed in the dye-sensitized solar cell. The factor of preventing the deterioration is considered that the current regulation was applied to the string by the power generation control apparatus so as to be equal to or smaller than the regulation current value Iₗᵢₘ.

As above, the embodiments according to the present application have been described specifically, whereas the present application is not limited to the above-mentioned embodiments but may be modified within the spirit of the present application variously.

For example, the configurations, methods, processes, shapes, materials, numerical values and the like in the above-mentioned embodiments are merely examples and different configurations, methods, processes, shapes, materials, numerical values and the like may be employed as necessary.

Moreover, the configurations, methods, processes, shapes, materials, numerical values and the like in the above-mentioned embodiments may be combined with one another within the spirit of the present application.

Additionally, the present application may also be configured as below.

(1) A power generation control apparatus including:

a measurement part measuring a voltage and a current of a photoelectric transducer;

a regulation part regulating a current flowing through the photoelectric transducer; and

a control part analyzing a shape of a current-voltage curve from the voltage and the current measured by the measurement part, and controlling the regulation part based on a result of the analysis to regulate the current flowing through the photoelectric transducer.

(2) The power generation control apparatus according to (1),

wherein the analysis of the shape of the current-voltage curve is to determine presence or absence of occurrence of a step-like shape in the current-voltage curve.

(3) The power generation control apparatus according to (2),

wherein the determination of the presence or absence of the occurrence of the step-like shape in the current-voltage curve is to determine presence or absence of occurrence of an inflection point in the current-voltage curve.

(4) The power generation control apparatus according to (1),

wherein the control part calculates a regulation current value using a current value corresponding to a height of a step of the step-like shape, and regulates the current flowing through the photoelectric transducer such that the current flowing through the photoelectric transducer is equal to or smaller than the regulation current value.

(5) The power generation control apparatus according to (1),

wherein the photoelectric transducer has a virtual internal bypass diode, and wherein the control part regulates the current flowing through the photoelectric transducer such that a current flowing through the virtual internal bypass diode of the photoelectric transducer does not exceed a rated current of the internal bypass diode.

(6) The power generation control apparatus according to (5),

wherein the photoelectric transducer is a dye-sensitized photoelectric transducer.

(7) The power generation control apparatus according to (2),

wherein the regulation part sweeps the voltage of the photoelectric transducer, and wherein the measurement part measures the voltage and the current of the photoelectric transducer during the sweeping.

(8) The power generation control apparatus according to (7),

wherein the control part ends the voltage sweeping performed by the regulation part when it is determined that the occurrence of the step-like shape is present in the current-voltage curve.

(9) The power generation control apparatus according to any one of (1) to (8),

wherein the photoelectric transducer constitutes a string.

(10) A power generation control apparatus including:

a measurement part measuring a voltage and a current of a photoelectric conversion part;

a regulation part regulating a current flowing through the photoelectric conversion part; and

a control part analyzing a shape of a current-voltage curve from the voltage and the current measured by the measurement part, and controlling the regulation part based on a result of the analysis to regulate the current flowing through the photoelectric conversion part.

(11) The power generation control apparatus according to (10),

wherein the photoelectric conversion part includes a photoelectric transducer and a bypass diode.

(12) The power generation control apparatus according to (11),

wherein the photoelectric transducer is a silicon-based photoelectric transducer.

(13) A power generation control method including:

analyzing a shape of a current-voltage curve of a photoelectric transducer; and

regulating a current flowing through the photoelectric transducer based on a result of the analysis.

(14) A power generation control method including:

analyzing a shape of a current-voltage curve of a photoelectric conversion part; and

regulating a current flowing through the photoelectric conversion part based on a result of the analysis.

(15) A power generation system including:

a power generation apparatus; and

a power generation control apparatus controlling the power generation apparatus,

wherein the power generation apparatus includes a string including a plurality of photoelectric transducers connected in series, and

wherein the power generation control apparatus includes
a measurement part measuring a voltage and a current of a string,
a regulation part regulating a current flowing through the string, and
a control part analyzing a shape of a current-voltage curve from the voltage and the current measured by the string, and controlling the regulation part based on a result of the analysis to regulate the current flowing through the string.
   (16) A power storage system including:

a power generation apparatus;

a power generation control apparatus controlling the power generation apparatus; and

an electric power storage storing power generated by the power generation control apparatus,

wherein the power generation apparatus includes a string including a plurality of photoelectric transducers connected in series, and

wherein the power generation control apparatus includes
a measurement part measuring a voltage and a current of a string,
a regulation part regulating a current flowing through the string, and
a control part analyzing a shape of a current-voltage curve from the voltage and the current measured by the string, and controlling the regulation part based on a result of the analysis to regulate the current flowing through the string.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A power generation control apparatus comprising:
a measurement part measuring a voltage and a current of a photoelectric transducer;
a regulation part regulating a current flowing through the photoelectric transducer; and
a control part analyzing a shape of a current-voltage curve from the voltage and the current measured by the measurement part, and controlling the regulation part based on a result of the analysis to regulate the current flowing through the photoelectric transducer.

2. The power generation control apparatus according to claim 1,
wherein the analysis of the shape of the current-voltage curve is to determine presence or absence of occurrence of a step-like shape in the current-voltage curve.

3. The power generation control apparatus according to claim 2,
wherein the determination of the presence or absence of the occurrence of the step-like shape in the current-voltage curve is to determine presence or absence of occurrence of an inflection point in the current-voltage curve.

4. The power generation control apparatus according to claim 1,
wherein the control part calculates a regulation current value using a current value corresponding to a height of a step of the step-like shape, and regulates the current flowing through the photoelectric transducer such that the current flowing through the photoelectric transducer is equal to or smaller than the regulation current value.

5. The power generation control apparatus according to claim 1,
wherein the photoelectric transducer has a virtual internal bypass diode, and
wherein the control part regulates the current flowing through the photoelectric transducer such that a current flowing through the virtual internal bypass diode of the photoelectric transducer does not exceed a rated current of the internal bypass diode.

6. The power generation control apparatus according to claim 5,
wherein the photoelectric transducer is a dye-sensitized photoelectric transducer.

7. The power generation control apparatus according to claim 2,
wherein the regulation part sweeps the voltage of the photoelectric transducer, and
wherein the measurement part measures the voltage and the current of the photoelectric transducer during the sweeping.

8. The power generation control apparatus according to claim 7,
wherein the control part ends the voltage sweeping performed by the regulation part when it is determined that the occurrence of the step-like shape is present in the current-voltage curve.

9. The power generation control apparatus according to claim 1,
wherein the photoelectric transducer constitutes a string.

10. A power generation control apparatus comprising:
a measurement part measuring a voltage and a current of a photoelectric conversion part;
a regulation part regulating a current flowing through the photoelectric conversion part; and
a control part analyzing a shape of a current-voltage curve from the voltage and the current measured by the measurement part, and controlling the regulation part based on a result of the analysis to regulate the current flowing through the photoelectric conversion part.

11. The power generation control apparatus according to claim 10,
wherein the photoelectric conversion part includes a photoelectric transducer and a bypass diode.

12. The power generation control apparatus according to claim 11,
wherein the photoelectric transducer is a silicon-based photoelectric transducer.

13. A power generation control method comprising:
analyzing a shape of a current-voltage curve of a photoelectric transducer; and
regulating a current flowing through the photoelectric transducer based on a result of the analysis.

14. A power generation control method comprising:
analyzing a shape of a current-voltage curve of a photoelectric conversion part; and
regulating a current flowing through the photoelectric conversion part based on a result of the analysis.
